(19) United States
(12) Patent Application Publication
(10) Pub. No.: US 2025/0010583 A1
(43) Pub. Date: Jan. 9, 2025

(54) LAMINATED GLASS SPEAKER SYSTEM INCLUDING ASYMMETRICAL PIEZOELECTRIC EXCITERS FOR ZONAL SOUND CREATION

(71) Applicant: GM GLOBAL TECHNOLOGY OPERATIONS LLC, Detroit, MI (US)

(72) Inventors: Julien P. Mourou, Bloomfield Hills, MI (US); Bo Yang, Rochester Hills, MI (US); Gerard Parij, Warren, MI (US)

(21) Appl. No.: 18/348,446

(22) Filed: Jul. 7, 2023

(51) Int. Cl. B32B 17/10; B60J 1/00; H04R 17/00

(52) U.S. Cl. CPC B32B 17/10165; B32B 17/10036; B32B 17/10761; B32B 17/10779; B60J 1/001; H04R 17/00; B32B 2307/102; B32B 2307/7376; B32B 2605/00; H04R 2499/13

(57) ABSTRACT

Laminated glass speaker systems include at least one pair of asymmetrical piezoelectric exciters within a laminating material used to effectively bond glass panels together. The laminated glass speaker system can be utilized about the vehicle anywhere sound generation is desired, e.g., passenger windows, fixed or sliding roofing systems, front windshield, rear windshield, side windows, rear quarter glasses, and the like. The piezoelectric exciters are generally off-axis relative to a centerline longitudinally extending between the glass panels and act as a diaphragm to produce sound upon vibration.

### INTRODUCTION

The subject disclosure relates to laminated vehicle glass structures, and more particularly, to laminated vehicle glass structures including asymmetric piezoelectric exciters for zonal sound generation, wherein the piezoelectric exciters are at least partly and/or fully embedded with the polymeric laminating material provided between glass panels.

Laminate glass is a type of safety glass commonly used in vehicles that is composed of two or more glass sheets bonded together by a layer of polyvinyl butyral (PVB) or other similar materials. The glass and the interlayer are heated and pressed together to create a strong and durable bond. Laminated glass offers several benefits over traditional single-pane glass, including increased strength, durability, and safety. When laminated glass is broken, the interlayer holds the glass fragments together, reducing the risk of injury from sharp edges and preventing the glass from shattering and falling apart.

Known glass panels can be made of heat-ray absorbing glass, regular clear glass, green glass, or UV green glass. In some embodiments, adjustments can be made so that the outer glass panel ensures a desired solar and/or tint absorptance and the inner glass panel provides visible light transmittance. Other materials can also be used as laminated transparent panels including but not limited to polycarbonate resins.

Current speaker technology utilized in vehicles generally employ electromagnetic speakers including a moving coil and cone technology that are placed within doors, instrument panels, roofing, and elsewhere throughout the vehicle to produce sound. The speakers function as transducers to convert amplified electrical waves from an infotainment system, phone, or the like into sound pressure waves that propagate in the air for occupants to hear. An amplifier feeds a signal to two terminals on the back of a speaker. These terminals pass the current into a cylindrical coil of wire, which is suspended in the circular gap between the poles of a permanent magnet. This coil moves back and forth inside the magnetic field as the current passing through it alternates in direction with the signal applied, per Faraday's law. The center of the speaker cone is attached to one end, which gets driven back and forth by the moving coil. This cone is held at its edges by an airtight suspension or surround. As the cone moves, it pushes and pulls the surrounding air; by doing so it creates pressure waves in the air in the form of sound.

Coil and cone type speakers can add substantial weight to a vehicle, require individual installation and connection, occupy valuable interior trim space, allow significant road noise intrusion, and are subject to substantial shock and environmental abuse. Moreover, today's high end automotive audio systems require multiple speakers discretely positioned in highly defined locations of the vehicle interior. This takes away from other functions such as the roof opening size for fixed or moving roof glass panels. Still further, because of the limited trim space available for speaker placement, the speakers can be poorly positioned for listening. Their on-axis radiation is typically directed low in the vehicle toward occupants' legs and midsections rather than at the occupants' ears. The direct sound from the speaker to the listener is typically far off-axis and highly variable in frequency response with typically insufficient high frequencies. In the high noise environment of a vehicle, this typically results in mid and high frequency audio information getting lost. “Imaging”, the perception of where sound is coming from, is also adversely affected since the loudspeakers are low in the vehicle; for the front passengers, the audio image is pulled down into the doors while the rear passengers have an image to the side or rear instead of what should be presented in front of them.

Accordingly, it is desirable to better position the speakers within the vehicle while minimizing trim space requirements, weight, road intrusion noise, abuse, and the like.

### SUMMARY

In one exemplary embodiment of the present disclosure, a laminated glass structure for vehicles includes a first glass panel including an outer surface facing an environment about the vehicle and an inner surface; and a second glass panel including an inner surface and an outer surface facing an interior of the vehicle. A laminating material is intermediate the inner surfaces of the first and second glass panels effectively bonding the first panel to the second panel. At least one pair of spaced apart piezoelectric exciters is provided between the first and second glass panels. Each piezoelectric exciter has a thickness less than a thickness of the laminating material. One of the piezoelectric exciters is at a different vertical location relative to the other piezoelectric exciter and both piezoelectric exciters are offset relative to a centerline longitudinally extending between the first and second glass panels.

In other aspects, one piezoelectric exciter is provided on the inner surface of the first glass panel and the other piezoelectric exciter is provided on the inner surface of the second glass panel. Each one of the piezoelectric exciters in the at least one pair can be completely encapsulated within the laminating material.

In one or more embodiments, the laminated glass structure further includes a plastic layer including first and second planar surfaces and a sidewall extending between the first and second planar surfaces defining a thickness of the plastic layer, wherein one piezoelectric exciter is provided on the first planar surface and the other piezoelectric exciter is provided on the second planar surface of the plastic layer. The plastic layer can include polyethylene terephthalate.

The laminating material can include polyvinyl butyral resin or ethylene vinyl acetate. The laminating material can have a thickness of about 0.3 millimeters to about 2 millimeters, and each of the piezoelectric exciters cab have a thickness less than 0.6 millimeters. In one or more aspects, the piezoelectric exciters are powered via an infotainment system to produce sound. The piezoelectric exciters can include lead zirconium titanate, calcium titanate, barium titanate, lead titanate, or strontium titanate.

In another embodiment of the present disclosure, a laminated glass structure for a vehicle includes a first glass panel including an outer surface facing an environment about the vehicle and an inner surface; and a second glass panel including an inner surface and an outer surface facing an interior of the vehicle. A laminating material is intermediate the inner surfaces of the first and second glass panels effectively bonding the first panel to the second panel. At least one pair of spaced apart piezoelectric exciters is provided between the first and second glass panels and are at the same vertical location. The at least one pair of piezoelectric exciters are offset relative to a centerline longitudinally extending between the first and second glass panels. Each one of the piezoelectric exciters has a thickness less than a thickness of the laminating material and a selected one of the piezoelectric exciters in the least one pair is configured to produce sound of an opposite phase relative to the other one of the piezoelectric exciters.

In one or more aspects, the selected one of the piezoelectric exciters in the least one pair configured to produce sound of the opposite phase can include a reversed polarity of positive and negative wiring for power relative to the other piezoelectric exciter. In other aspects, the selected one of the piezoelectric exciters in the least one pair configured to produce sound of the opposite phase can include a reversed orientation and the same polarity of positive and negative wiring for power relative to the other piezoelectric exciter. During operation, the at least one pair of piezoelectric exciters cancel sound produced at a symmetry plane between the pair of piezoelectric exciters.

In one or more aspects, there are two pairs of the piezoelectric exciters equidistantly spaced apart, wherein each adjacent pair of piezoelectric exciters include one piezoelectric exciter configured to produce sound of the opposite phase relative to the other and each pair of piezoelectric exciters diagonal to one another, are of the same phase.

In the laminated glass structures, the laminating material has a thickness of about 0.3 millimeters to about 2 millimeters, and wherein the piezoelectric exciters have a thickness less than 0.6 millimeters. The piezoelectric exciters can be powered via an infotainment system to produce the sound. The laminating material can include polyvinyl butyral resin or ethylene vinyl acetate.

In one or more embodiments, the laminated glass structure further comprising a plastic layer disposed within the laminating material including first and second planar surfaces and a sidewall extending between the first and second planar surfaces defining a thickness of the plastic layer, wherein the plastic layer comprises polyethylene terephthalate.

In yet another embodiment of the present disclosure, a laminated glass structure for a vehicle includes an outer glass panel having a thickness of about 1.6 to about 3.5 millimeters, the outer glass panel including an outer surface exposed to an environment about the vehicle and an inner surface; and an inner glass panel having a thickness of about 0.7 millimeters to about 3.5 millimeters, the inner glass panel including an inner surface and an outer surface exposed an interior of the vehicle. A laminating material having a thickness of about 0.3 millimeters to about 2 millimeters is between the outer glass panel and the inner glass panel and in contact with the inner surfaces of the outer and inner glass panels. The laminating material includes polyvinyl butyral resin or ethylene vinyl acetate. At least one pair of asymmetric piezoelectric exciters are between the outer and inner glass panels and offset relative to a centerline extending between the inner surfaces of the outer and inner glass panels. The at least one pair of asymmetric piezoelectric exciters are ring-shaped and have a thickness less than a thickness of the laminating material. Each piezoelectric exciter in the at least one pair is at a different vertical location or the same vertical location. When at the same vertical location, one of the piezoelectric exciters is configured to produce sound of an opposite phase. The sound cancels out at a symmetry plane between the piezoelectric exciters in the at least one pair. The laminated glass structure forms a fixed or sliding roofing system, one or more passenger movable windows, a front windshield and/or a rear windshield.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates a perspective view of an exemplary vehicle including numerous laminated glass panels;

FIG. 2 is a cross sectional view of a laminated glass structure including a pair of spaced apart asymmetric piezoelectric exciters positioned on each of inner surfaces of the glass panels and partly embedded within a laminating material in accordance with one or more embodiments of the present disclosure;

FIG. 3 is a cross sectional view of a laminated glass structure including a pair of spaced apart asymmetric piezoelectric exciters positioned on the same inner surface of a selected one of the glass panels, wherein the piezoelectric exciters are configured to produce sound of opposite phases in accordance with one or more embodiments of the present disclosure;

FIG. 4 is a cross sectional view of a laminated glass structure including a pair of spaced apart asymmetric piezoelectric exciters positioned within a laminating material on opposing locations relative to a centerline longitudinally extending between the glass panels in accordance with one or more embodiments of the present disclosure;

FIG. 5 is a cross sectional view of a laminated glass structure including a rigid plastic layer at the centerline between opposing glass panels and asymmetric piezoelectric exciters embedded within a laminating material off-axis relative to the center line in accordance with one or more embodiments of the present disclosure;

FIG. 6 depicts a contour plot of total sound pressure level in decibels for a laminated glass structure including a pair of spaced apart asymmetric piezoelectric exciters configured to produce sound at opposite phases in accordance with one or more embodiments of the present disclosure;

FIG. 7 depicts a contour plot of a cross sectional view of total acoustic pressure in pascals for the laminated glass structure of FIG. 5 taken along lines A-A of FIG. 6 in accordance with one or more embodiments of the present disclosure; and

FIG. 8 depicts a contour plot of total sound pressure level in decibels for a laminated glass structure including four spaced apart asymmetric piezoelectric exciters configured to produce sound in accordance with one or more embodiments of the present disclosure.

### DETAILED DESCRIPTION

The following description is merely exemplary in nature and is not intended to limit the present disclosure, its application or uses.

In accordance with an exemplary embodiment, an automotive vehicle includes a laminated glass structure including at least one pair of ceramic piezoelectric exciters bonded within a laminated glass panel in an asymmetric fashion to recreate the zonal effects of current electromagnetic systems such as those that are located in headliner mounted systems. Laminated glass panels for automotive vehicles are generally laminated structures including an exterior glass panel including sides 1, 2 and an interior glass panel including sides 3, 4 laminated together using a polymeric laminating material. The exterior facing surface of the exterior glass-side panel is referred to as side 1 and the corresponding inner surface is referred to as side 2. The inner surface of the interior glass-side panel is referred to as side 3 and the corresponding interior-facing glass surface is referred to as side 4.

The at least one pair of piezoelectric exciters can be asymmetrically positioned within the laminate, wherein one piezoelectric exciter is bonded directly to the side 2 and the other piezoelectric exciter is bonded to side 3 of the automotive laminated glass, for example. The pair of piezoelectric exciters are spaced apart from one another and can be placed in locations proximate to a seated occupant. This asymmetric arrangement creates multiple zonal sound generation with dead spots between the zones. The laminated glass structure in accordance with the present disclosure can be used for front windshields, fixed roofing systems, moving glass roof systems, side moving glasses, rear quarter glasses, and rear glasses and is generally formed from glass panels having a shape intended for its use. For example, fixed roofing applications generally utilize rectangular shaped glass panels that are laminated together.

The piezoelectric exciters are ring-shaped and are a type of exciters that uses piezoelectric materials to convert electrical energy into mechanical energy. The exciters can be a ring-shaped piezoelectric material, typically made of lead zirconium titanate (PZT), that is sandwiched between two electrodes. When an electric voltage is applied to the electrodes, the piezoelectric material expands or contracts, causing the ring to deform and produce mechanical motion. In the present disclosure, the piezoelectric exciters have a thickness less than a thickness of the laminate material(s) intermediate the glass panels. In one or more embodiments of the present disclosure, the piezoelectric exciters are selected to have a thickness less than 0.6 millimeters (mm), wherein at least one pair of piezoelectric exciters are asymmetrically disposed within the laminate glass as will be described in greater detail to provide zonal sound generation.

Piezoelectric exciters suitable for use in the present disclosure include, but are not limited to, a hard piezoceramic material for exciting and causing vibration of the glass panels. Exemplary hard piezoceramic material include piezoelectric shaped rings such as those that are circular, oval, polygonal, or any other geometric shape can be used and generally function as diaphragms in the laminated glass structure in a manner similar to coil-cone type speakers.

Hard piezoelectric exciters generally have a higher mechanical quality factor compared to soft piezoelectric exciters that are often configured as a film. Hard piezoelectric ceramics are suitable for dynamic/on-resonance applications and the higher mechanical quality factor provides more efficient energy conversion (from electrical to work), hard materials can withstand high levels of electrical excitation and mechanical stress, generate less heat during this process and are not easily poled or depoled except at elevated temperature. Compared to soft piezoelectric materials, hard piezoelectric materials exhibit reduced strain because of the lower charge coefficients (d).

In one or more embodiments, hard piezoelectric rings fabricated with PZT-4 material (lead zirconium titanate) can be used, for example, which can be fabricated to be relatively thin and act as a diaphragm. Other types include, but are not limited to calcium titanate, barium titanate, lead titanate, strontium titanate, and the like.

Regulated power can be supplied to the piezoelectric exciters via the vehicle's infotainment system. For example, the infotainment amplifier system can be electrically coupled to the piezoelectric exciters using patterned conductive coatings directly on the glass surface within the laminate structure and/or through the use of negative and positive wires electrically coupled to the piezoelectric exciter, which may or may not be insulated if sufficiently spaced apart from one another. In the case of a patterned conductive surface within the laminate structure, the conductive surface would be provided on side 2 or 3 of the glass panels or on a selected surface of a plastic layer, if present within the laminating material.

Although reference is made to two glass panels, it should be apparent that more than two glass panels could be utilized although the increases in weight would make this less practical for automotive applications. The laminated glass assemblies including the asymmetric piezoelectric exciters can be used in in vehicles wherever laminated glass assemblies are utilized including, for example, fixed glass roofing systems, front windshields, side moving glasses, rear quarter glasses, rear glasses, and the like. Unlike coil and cone-based speakers, the piezoelectric exciters advantageously occupy minimal space, are of significantly lower weight, can be used to occupy space within the vehicle previously not used for speaker placement, (i.e., in the laminated glass structure), and can be located above and/or next to the occupant(s) as opposed to coil and cone speakers, which are often placed within trim panels below the vehicle windows, (e.g., door panels).

As used herein, when referring to the laminated glass structure including two glass panels, the terms “ambient glass-side” and “exterior glass-side” are interchangeable and generally refer to the glass panel including a surface that is exposed to the environment. In contrast, the terms “cabin glass-side” and “interior glass-side” are interchangeable and generally refer to the glass panel including a surface exposed to the interior of the vehicle. The term “asymmetrical” refers to the vertical location of a pair of piezoelectric exciters within a polymeric laminating material, wherein each piezoelectric exciter is at a different plane between the glass panels in a laminated glass structure or the pair of piezoelectric exciter are at the same vertical location (same plane), wherein one of the piezoelectric exciters is configured to produce sound waves of an opposite phase relative to the other piezoelectric exciter in the pair.

Conventional techniques related to laminated glass manufacturing processes may or may not be described in detail herein. Moreover, the various tasks and process steps described herein can be incorporated into a more comprehensive procedure or process having additional steps or functionality not described in detail herein. In particular, various steps in the windshield manufacturing processes are well known and so, in the interest of brevity, many conventional steps will only be mentioned briefly herein or will be omitted entirely without providing the well-known process details.

Spatially relative terms, e.g., “beneath,” “below,” “lower,” “above,” “upper,” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device can be otherwise oriented (rotated 90 degrees or at other orientations) and the spatially relative descriptors used herein interpreted accordingly.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects. Additionally, the terms “upper”, “lower”, “top”, “bottom”, “left,” and “right,” and derivatives thereof shall relate to the described structures, as they are oriented in the drawing figures. The same numbers in the various figures can refer to the same structural component or part thereof.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

There are generally multiple ways to achieve asymmetry with pairs of piezoelectric exciters. The piezoelectric exciters can be attached to opposing inner surfaces of the glass panels, (e.g., on sides 2 and 3); the piezoelectric exciters can be in the same plane within the laminate materials albeit offset relative to the centerline axis, wherein one of the piezoelectric exciters is flipped in orientation such that sound produced by each piezoelectric exciter is of an opposite phase relative to other; and the piezoelectric exciters can be in the same plane within the laminate materials albeit offset relative to the centerline axis, wherein the polarity of the positive and negative wires for powering the piezoelectric exciters is of a different polarity for one of the piezoelectric exciters relative to the other piezoelectric exciter.

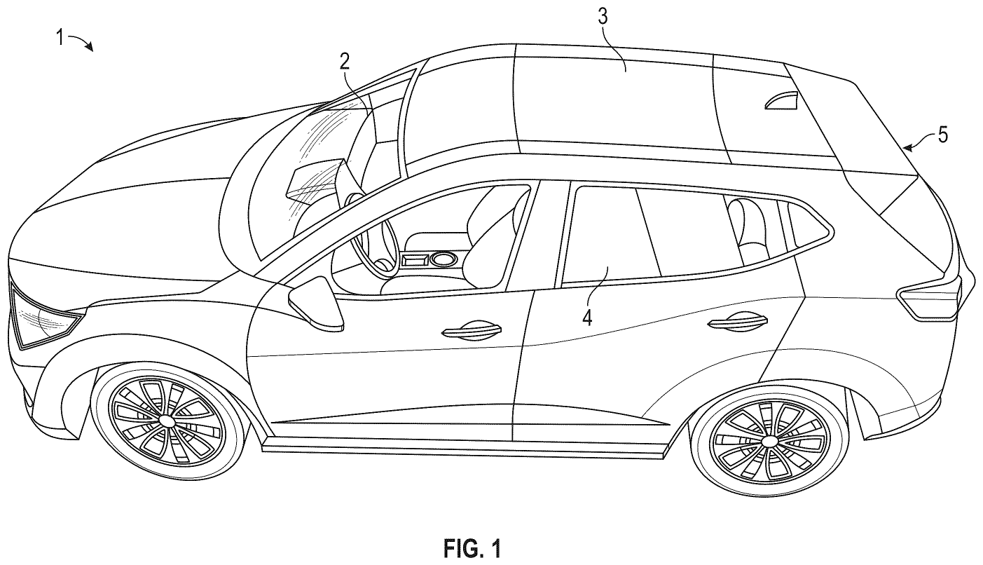

As shown in FIG. 1, a perspective view of an exemplary vehicle 1 is depicted and includes numerous glass panels for front windshields 2, fixed roofing systems 3, moving glass roof systems (not shown), side moving glasses 4, rear quarter glasses (not shown), and rear glasses 5. The arrangement, shape, and/or location will generally vary among different vehicles.

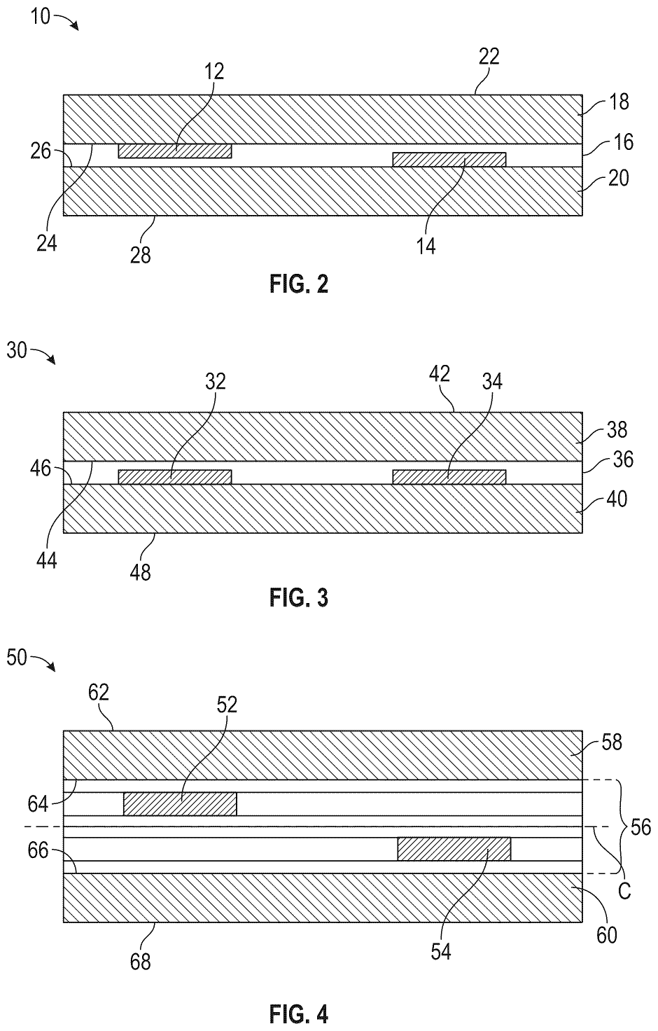

As shown in FIG. 2, there is a cross-sectional view of a laminated glass structure 10 in accordance with one or more embodiments of the present disclosure for an automotive vehicle, wherein the piezoelectric exciters can be attached to opposing inner surfaces of the glass panels, (e.g., on sides 2 and 3). The laminated glass structure 10 includes at least one pair of asymmetrically disposed piezoelectric exciters 12, 14 within one or more polymeric laminating materials 16, one of which is shown, used to laminate a first glass panel 18 to a second glass panel 20. The first glass panel 18 includes an outer surface 22 (side 1) facing an exterior environment about the vehicle and an inner surface 24 (side 2). The second glass panel 20 includes an inner surface 26 (side 3) and an exterior surface 28 (side 4) facing an interior of the vehicle. The piezoelectric exciters 12, 14 are asymmetrical positioned within the polymeric laminating material 16 and on opposite sides of a centerline (C) (see, for example, FIG. 4) longitudinally extending between the first and second glass panels 18, 20, respectively, within a thickness of the polymeric laminating material 16, (i.e., the piezoelectric exciters are biased relative to the centerline). Piezoelectric exciter 12 is located on the inner surface 24 of the first glass panel 18, (i.e., side 2) and piezoelectric exciter 14 is located on the inner surface 26 of the second glass panel 20, (i.e., side 3).

The piezoelectric exciters 12, 14 can be secured to a surface of a sheet of the polymeric laminating material prior to assembly or to a corresponding glass surface during the assembly and lamination process without the need for special adhesives or preparations, bezels in the case of packaging grab handles being located on the roof, or other labor intensive measures. There are significant manufacturing benefits by providing the piezoelectric exciters in the polymeric laminating material stack of layers as opposed to installing cone-type speakers.

Although there is no particular limitation on the thickness of the laminated glass structure, for a roofing application the total thickness of the outer glass panel 18 is generally set within a range of about 1.6 to about 3.5 millimeters (mm) and the inner glass panel 20 is generally set within a range of about 0.7 to about 3.5 mm. The polymeric laminating material 16 and any additional sheets that may be used for various applications such as solar reflectivity, for example, can have a thickness within a range of 0.3 mm to about 2 mm, although greater or lesser thicknesses can be utilized. By way of example, the laminate material by itself can have a thickness of about 0.80 mm.

The process of laminating the laminated glass structure generally includes application of heat and pressure to bond two or more layers of glass together with a sheet layer of polymeric laminating material such as polyvinyl butyral, ethylene vinyl acetate, or the like, in between. The polymeric laminating material is usually melted or softened by the heat, allowing it to bond the glass layers together and create a strong, durable laminate.

The temperature range for laminating glass is typically between 120° C. and 150° C. (248° F. and 302° F.), although some processes may use higher or lower temperatures depending on the materials and equipment being used.

The pressure range for laminating glass can vary widely depending on the specific lamination process, but it is typically between 10 and 15 psi (0.7 and 1 bar). Some processes may use higher pressures to achieve a stronger bond, while others may use lower pressures to reduce the risk of damaging the glass. In some applications, a mask layer, also called a decoration, can be formed of a ceramic, ceramic-metal or the like can be provided about the periphery of one or both of the glass panels prior to lamination. These are often referred to as ceramic inks and are fused to the glass during the bending process.

Turning now to FIG. 3, there is a cross-sectional view of a laminated glass structure 30 in accordance with one or more embodiments of the present disclosure, wherein a pair of spaced apart piezoelectric exciters 32, 34 are provided on the same inner surface, (e.g., side 2 or side 3). The laminated glass structure 30 includes a first glass panel 38, a second glass panel 40 and one or more laminating materials 36 therebetween. The first glass panel 38 includes an outer surface 42 (side 1) facing an exterior environment about the vehicle and an inner surface 44 (side 2). The second glass panel 40 includes an inner surface 46 (side 3) and an exterior surface 48 (side 4) facing an interior of the vehicle. As shown, the pair of piezoelectric exciters 32, 34 are both located on inner surface 46 (side 3) of the second glass panel 40 at the same vertical location between the first and second glass panels 38, 40, respectively. The piezoelectric exciters 32, 34 have a thickness less than a thickness of the laminating material 36. To provide asymmetry, one of the piezoelectric exciters 32 or 34 is flipped in orientation relative to the other such that the piezoelectric exciters produce sound of opposite phases. In one or more embodiments, instead of flipping one of the piezoelectric exciters 32, or 34 relative to the other, the polarity of the positive and negative wires powering the piezoelectric exciters are reversed to produce sound from each piezoelectric exciter of opposite phases relative to one another.

In FIG. 4, there is shown a cross-sectional view of a laminated glass structure 50 for a vehicle in accordance with one or more embodiments of the present disclosure including a pair of spaced apart piezoelectric exciters 52, 54 completely encapsulated within a polymeric laminating material 56 provided between a first glass panel 58 and a second glass panel 60. The first glass panel 58 includes an outer surface 62 (side 1) facing an exterior environment about the vehicle and an inner surface 64 (side 2). The second glass panel 60 includes an inner surface 66 (side 3) and an outer surface 68 (side 4) facing an interior of the vehicle. During assembly and lamination, multiple sheets of the polymeric laminating material 56 are provided, wherein the piezoelectric exciters 52, 54 can be adhesively attached to a selected surface of the sheet material such that the piezoelectric exciters 52, 54 are at different vertical locations within the resulting laminate and on opposite sides of a centerline (C) longitudinally extending between the first and second glass panels 58, 60, respectively.

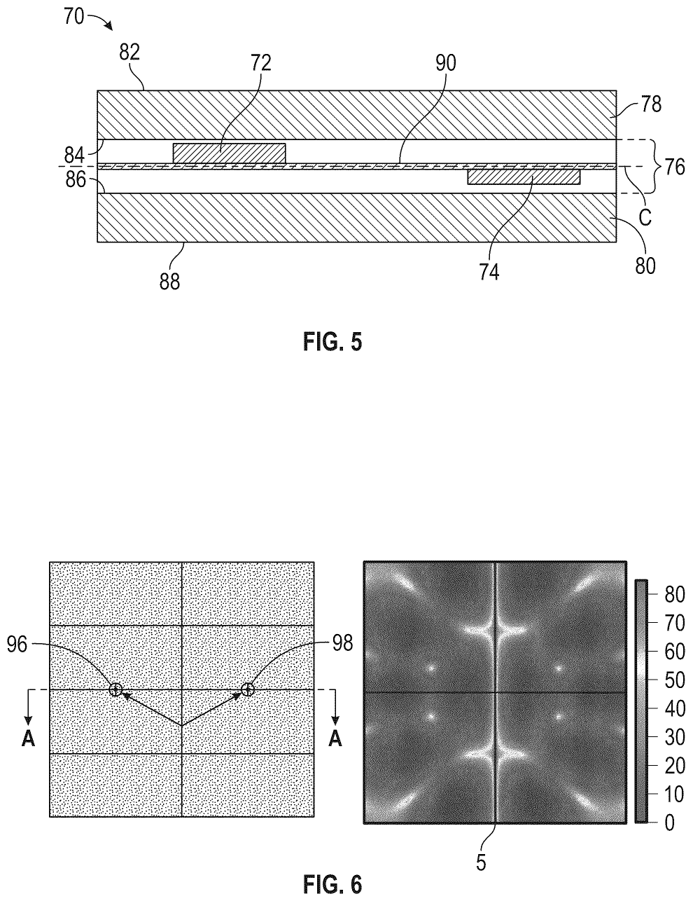

FIG. 5 illustrates a cross-sectional view of a laminated glass structure 70 in accordance with one or more embodiments of the present disclosure that includes a semi-rigid or rigid plastic layer 90 at the centerline (C) within the polymeric laminating material 76 between first and second glass panels 78, 80, respectively, to provide additional features to the laminated glass structure such as, for example, solar reflectivity. Exemplary plastic layers 90 are polyesters such as polyethylene terephthalate (PET), polycarbonate or the like.

The first glass panel 78 includes an outer surface 82 (i.e., side 1) facing the exterior about the vehicle and an inner surface 84 (i.e., side 2) and the second glass panel 80 includes an inner surface 86 (i.e., side 3) and an outer surface 88 (i.e., side 4) facing the vehicle interior. During assembly and lamination, the pair of piezoelectric exciters 72, 74 can be adhesively coupled to the plastic layer 90 on opposite sides thereof at desired locations or on a selected sheet surface of the polymeric laminating material 76 prior to application of heat and pressure to form the laminated glass structure 70 such that the piezoelectric exciters 72, 74 are on opposite sides of the plastic layer 90. Although the piezoelectric exciters 72, 74 are provided on opposing surfaces of the rigid plastic layer, it should be apparent that the piezoelectric exciters 72, 74 can be provided on the same side, either proximate to the first glass panel 78 or proximate to the second glass panel 80, and still produce sound so long as the piezoelectric exciters 72, 74 are configured to produce sound of opposite phases as previously described. The plastic layer 90 can include an electrically conductive metal coating (not shown) that can be patterned such as by laser etching to provide power to the exciters or the laminated glass structure can include positive and negative wires, which can be electrically coupled to the infotainment system to provide power.

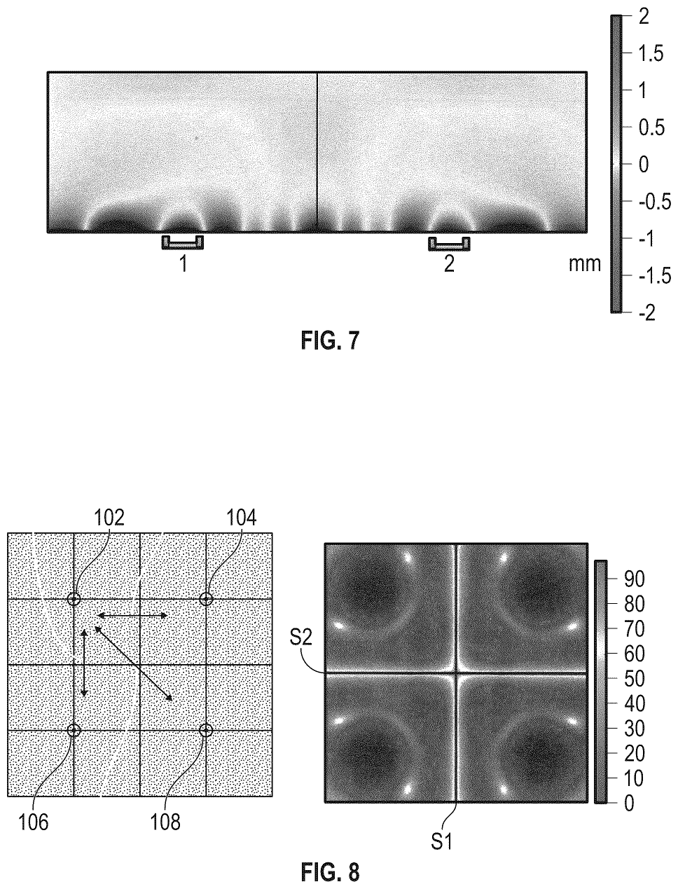

FIG. 6 depicts a top-down view of an exemplary laminated glass structure including a pair of asymmetric piezoelectric exciters 96, 98 configured to produce sound of opposite phases as described above and a contour plot of the resulting total sound pressure (dB, scale on right side of Figure) when actuated. FIG. 7 is a cross section of the corresponding total acoustic pressure (pa) taken along lines A-A of the top-down view provided in FIG. 6 for the pair of piezoelectric exciters 96, 98. As shown in these Figures, sound produced from this double asymmetric arrangement cancels out at the symmetry plane (S) between the pair of piezoelectric exciters. Applicants have found that the sound field is more uniform and louder than that for the double symmetric sources (i.e., not asymmetric) in certain areas.

FIG. 8 depicts a top-down view of an exemplary laminated glass structure including four spaced apart asymmetric piezoelectric exciters 102, 104, 106, 108 and a contour plot of the resulting total sound pressure (dB) for the four asymmetric piezoelectric exciters, such as may be desired for a panoramic roofing glass panel overlying four occupants of the vehicle. Each of the four piezoelectric exciters 102, 104, 106, 108 is positioned above a location corresponding to each of the four occupants and spaced apart relative to one another as shown. The adjacent piezoelectric exciters include one piezoelectric exciter configured to produce sound of the opposite phase (pairs 102, 104; 102, 106; 104, 108; and 106, 108) relative to the other in the manner previously described whereas the pairs of piezoelectric exciters at opposing corners, (i.e., the piezoelectric exciters diagonal to one another, are of the same phase, e.g., 102, 108; and 104, 106). As shown in the contour plot, the sound field from the four asymmetric sources can be configured to cancel out at symmetry planes S1, S2 and is much more uniform and louder than that from double asymmetric sources in certain areas (see FIG. 5 for comparison).

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A laminated glass structure for a vehicle comprising:
a first glass panel including an outer surface facing an environment about the vehicle and an inner surface;
a second glass panel including an inner surface and an outer surface facing an interior of the vehicle;
a laminating material intermediate the inner surfaces of the first and second glass panels effectively bonding the first glass panel to the second glass panel; and
at least one pair of spaced apart piezoelectric exciters between the first and second glass panels, wherein each piezoelectric exciter has a thickness less than a thickness of the laminating material, and wherein one of piezoelectric exciters is at a different vertical location relative to the other piezoelectric exciter, and wherein the at least one pair of piezoelectric exciters are offset relative to a centerline longitudinally extending between the first and second glass panels.

2. The laminated glass structure of claim 1, wherein one piezoelectric exciter is provided on the inner surface of the first glass panel and the other piezoelectric exciter is provided on the inner surface of the second glass panel.

3. The laminated glass structure of claim 1, wherein each one of the piezoelectric exciters in the at least one pair is completely encapsulated within the laminating material.

4. The laminated glass structure of claim 1 further comprising a plastic layer including first and second planar surfaces and a sidewall extending between the first and second planar surfaces defining a thickness of the plastic layer, wherein one piezoelectric exciter is provided on the first planar surface and the other piezoelectric exciter is provided on the second planar surface of the plastic layer.

5. The laminated glass structure of claim 4, wherein the plastic layer comprises polyethylene terephthalate.

6. The laminated glass structure of claim 1, wherein the laminating material comprises polyvinyl butyral resin or ethylene vinyl acetate.

7. The laminated glass structure of claim 1, wherein the laminating material has a thickness of about 0.3 millimeters to about 2 millimeters, and wherein each of the piezoelectric exciters have a thickness less than 0.6 millimeters.

8. The laminated glass structure of claim 1, wherein the piezoelectric exciters are powered via an infotainment system to produce sound.

9. The laminated glass structure of claim 1, wherein the piezoelectric exciters comprise lead zirconium titanate, calcium titanate, barium titanate, lead titanate, or strontium titanate.

10. A laminated glass structure for a vehicle comprising:
a first glass panel including an outer surface facing an environment about the vehicle and an inner surface;
a second glass panel including an inner surface and an outer surface facing an interior of the vehicle;
a laminating material intermediate the inner surfaces of the first and second glass panels effectively bonding the first glass panel to the second glass panel; and
at least one pair of spaced apart piezoelectric exciters are between the first and second glass panels at a same vertical location and offset relative to a centerline longitudinally extending between the first and second glass panels, wherein each one of the pair of piezoelectric exciters has a thickness less than a thickness of the laminating material; and wherein a selected one of the piezoelectric exciters in the least one pair of piezoelectric exciters is configured to produce sound of an opposite phase relative to the other one of the piezoelectric exciters.

11. The laminated glass structure of claim 10, wherein the selected one of the piezoelectric exciters in the least one pair configured to produce sound of the opposite phase comprises a reversed polarity of positive and negative wiring for power relative to the other piezoelectric exciter.

12. The laminated glass structure of claim 10, wherein the selected one of the piezoelectric exciters in the least one pair is configured to produce sound of the opposite phase comprises a reversed orientation and the same polarity of positive and negative wiring for power relative to the other piezoelectric exciter.

13. The laminated glass structure of claim 10, wherein, during operation, the at least one pair of piezoelectric exciters cancel sound produced at a symmetry plane between the pair of piezoelectric exciters.

14. The laminated glass structure of claim 10, wherein there are two pairs of the piezoelectric exciters equidistantly spaced apart, wherein each adjacent pair of piezoelectric exciters include one piezoelectric exciter configured to produce sound of the opposite phase relative to the other and each pair of piezoelectric exciters diagonal to one another, are of the same phase.

15. The laminated glass structure of claim 10, wherein the laminating material has a thickness of about 0.3 millimeters to about 2 millimeters, and wherein the piezoelectric exciters have a thickness less than 0.6 millimeters.

16. The laminated glass structure of claim 10, wherein the piezoelectric exciters are powered via an infotainment system to produce the sound.

17. The laminated glass structure of claim 10, wherein the laminating material comprises polyvinyl butyral resin or ethylene vinyl acetate.

18. The laminated glass structure of claim 10 further comprising a plastic layer disposed within the laminating material including first and second planar surfaces and a sidewall extending between the first and second planar surfaces defining a thickness of the plastic layer.

19. The laminated glass structure of claim 18, wherein the plastic layer comprises polyethylene terephthalate.

20. A laminated glass structure for a vehicle, the laminated glass structure comprising:
an outer glass panel having a thickness of about 1.6 to about 3.5 millimeters, the outer glass panel including an outer surface exposed to an environment about the vehicle and an inner surface;
an inner glass panel having a thickness of about 0.7 millimeters to about 3.5 millimeters, the inner glass panel including an inner surface and an outer surface exposed an interior of the vehicle;
a laminating material having a thickness of about 0.3 millimeters to about 2 millimeters is between the outer glass panel and the inner glass panel and in contact with the inner surfaces of the outer and inner glass panels, wherein the laminating material comprises polyvinyl butyral resin or ethylene vinyl acetate; and
at least one pair of asymmetric piezoelectric exciters offset relative to a centerline extending between the inner surfaces of the outer and inner glass panels, wherein the at least one pair of asymmetric piezoelectric exciters are ring shaped and have a thickness less than a thickness of the laminating material, wherein each piezoelectric exciter in the at least one pair is at a different vertical location of the same vertical location, wherein one of the piezoelectric exciters at the same vertical location is configured to produce sound of an opposite phase, and wherein the sound cancels out at a symmetry plane between the piezoelectric exciters in the at least one pair;
wherein the laminated glass structure forms a fixed or sliding roofing system, one or more passenger movable windows, a front windshield and/or a rear windshield.
